(19) United States
(12) Patent Application Publication
(10) Pub. No.: US 2025/0355109 A1
(43) Pub. Date: Nov. 20, 2025

(54) OBJECT RECOGNITION DEVICE AND OBJECT RECOGNITION METHOD

(71) Applicant: Mitsubishi Electric Corporation, Tokyo (JP)

(72) Inventors: Takuya FUNATSU, Tokyo (JP); Masanori MORI, Tokyo (JP)

(73) Assignee: Mitsubishi Electric Corporation, Tokyo (JP)

(21) Appl. No.: 18/871,505

(22) PCT Filed: Jul. 12, 2022
(86) PCT No.: PCT/JP2022/027363

§ 371 Date: Dec. 4, 2024

(51) Int. Cl. G01S 13/62

(52) U.S. Cl. CPC G01S 13/62

(57) ABSTRACT

An object recognition device includes a time measurement unit to measure a time, a data receiving unit to receive detection data from a plurality of sensors and associate the time with the detection data, a received data processing unit to calculate a detection data density, a prediction processing unit to predict a state value of the object corresponding to the associated time from a state value of the object at an immediately preceding associated time and generate a prediction result as prediction data, an adjusted determination region parameter generation unit to generate an adjusted determination region parameter by adjusting a parameter indicating a size of a determination region, a correlation processing unit to generate correlation data between the prediction data and the detection data, and an update processing unit to update the state value of the object on the basis of the correlation data.

### TECHNICAL FIELD

The present disclosure relates to an object recognition device and an object recognition method.

### BACKGROUND ART

An object recognition device has been proposed to identify, estimate the position of, or track an object using detection data of an object received from each of a plurality of sensors.

For example, an object recognition device disclosed in Patent Document 1 creates information on an object existing in a predetermined area on the basis of image information acquired from a millimeter wave radar and an image sensor mounted on a vehicle.

### CITATION LIST

### Patent Document

Patent Document 1: International Publication of Unexamined Application No. WO2021/106197

### SUMMARY OF THE INVENTION

### Problem to Be Solved by the Invention

In the object recognition device described in Patent Document 1, when it is to be determined (on the correlation) that prediction data and detection data are for the same object, a correlation range is adjusted in consideration of an error of a sensor and a position of a detection point. However, when correlation data representing the correlation between the prediction data and the detection data is to be calculated, there may be a case where a plurality of detection data having a state value of the object close to the prediction data exist, or conversely, a case where no detection data having the state value of the object exists. As a result, there is a possibility that erroneous correlation occurs when the plurality of detection data exist, while there is a possibility that non-correlation occurs when no detection data exists.

Therefore, depending on the accuracy of the prediction data or the detection data, it may be difficult to calculate the correlation between the prediction data and the detection data. However, the object recognition device described in Patent Document 1 does not particularly consider such a problem.

The present disclosure has been made to solve the above-described problem, and an object of the present disclosure is to provide an object recognition device and an object recognition method that prevent a correlation between prediction data and detection data from being erroneous correlation or non-correlation and have high recognition accuracy of an object.

### Means to Solve the Problem

An object recognition device according to the present disclosure includes a time measurement unit to measure a time, a data receiving unit to receive detection data of an object from each of a plurality of sensors and associate the time measured by the time measurement unit as an associated time with each of the received detection data, a received data processing unit to calculate a detection data density in a specific region set using prediction data on the basis of the detection data, a prediction processing unit to predict a state value of the object corresponding to the associated time associated by the data receiving unit from a state value of the object at an immediately preceding associated time and generate a prediction result as the prediction data, an adjusted determination region parameter generation unit to generate an adjusted determination region parameter by adjusting a parameter indicating a size of a determination region on the basis of the detection data density, the determination region being used for determining whether the prediction data and the detection data are based on the same object, a correlation processing unit to generate correlation data indicating a correlation between the prediction data and the detection data corresponding to the associated time in the adjusted determination region indicated by the adjusted determination region parameter, and an update processing unit to update the state value of the object on the basis of the correlation data.

An object recognition method according to the present disclosure includes a step of measuring a time, a step of receiving detection data of an object from each of a plurality of sensors and associating the time measured as an associated time with each of the received detection data, a step of calculating a detection data density in a specific region on the basis of the detection data, a step of predicting a state value of the object corresponding to the associated time from a state value of the object at an immediately preceding associated time and generating a prediction result as prediction data, a step of generating an adjusted determination region parameter by adjusting a parameter indicating a size of a specific region on the basis of the detection data density, the determination region being used for determining whether the prediction data and the detection data are based on the same object, a step of generating correlation data indicating a correlation between the prediction data and the detection data corresponding to the associated time in the adjusted determination region indicated by the adjusted determination region parameter, and a step of updating the state value of the object on the basis of the correlation data.

### Effect of the Invention

According to the object recognition device and the object recognition method of the present disclosure, since the determination region is adjusted on the basis of the detection data density, it is possible to easily prevent the correlation between the prediction data and the detection data from being erroneous correlation or non-correlation, and thus it is possible to achieve an effect of enabling the object recognition with high accuracy.

### BRIEF DESCRIPTION OF THE DRAWINGS

FIG. 1 is a block diagram showing a configuration of an object recognition device according to Embodiment 1;

FIG. 2 is a flowchart showing an object recognition method according to Embodiment 1;

FIG. 3 is a diagram for describing an example of a method of generating an adjusted determination region parameter by the object recognition method according to Embodiment 1;

FIG. 4 is a diagram for describing a feature of the object recognition method according to Embodiment 1;

FIG. 5 is a diagram for describing a feature of the object recognition method according to Embodiment 1;

FIG. 6 is a flowchart showing an object recognition method according to Embodiment 2;

FIG. 7 is a diagram showing an example of hardware of the object recognition device according to

Embodiment 1.

### DESCRIPTION OF EMBODIMENTS

### Embodiment 1

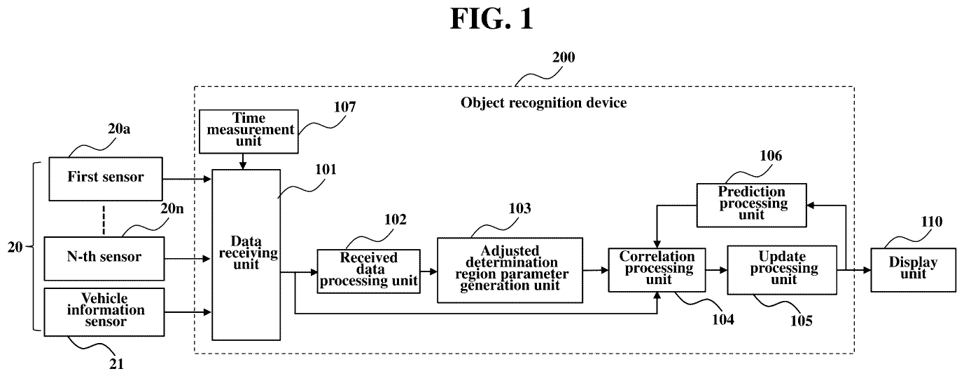

FIG. 1 is a block diagram showing a configuration of an object recognition device 200 according to Embodiment 1. Note that, in the following description, a density with respect to the number of detection data is referred to as a detection data density. The detection data density is calculated by defining a unit range as a denominator and the number of detection data within the unit range as a numerator, for example.

The object recognition device 200 according to Embodiment 1 includes a data receiving unit 101, a received data processing unit 102, an adjusted determination region parameter generation unit 103, a correlation processing unit 104, an update processing unit 105, a prediction processing unit 106, and a time measurement unit 107. The data receiving unit 101 is connected to a plurality of sensors 20 and a vehicle information sensor 21 that are installed outside the object recognition device 200. In addition, the update processing unit 105 is connected to a display unit 110 installed outside the object recognition device 200.

### Configuration of Sensors

The plurality of sensors 20 installed in an own-vehicle acquire information regarding an object present in a detectable detection range as detection data. The acquired detection data is transmitted to the data receiving unit 101 of the object recognition device 200. The detection data includes information on state values of an object such as a distance to the object to be detected, an azimuth angle of the object, or relative velocity of the object.

The plurality of sensors 20 are, for example, n sensors as shown in FIG. 1. The n sensors are individually referred to as a first sensor 20a, . . . , and an n-th sensor 20n.

The plurality of sensors 20 are sensors that receive light, electromagnetic waves, or the like radiated or reflected from an object, and apply signal processing or image processing to measure the distance to the object, the azimuth angle, the relative velocity, and the like. For example, a millimeter wave radar, a laser radar, an ultrasonic sensor, an infrared sensor, an optical camera, and the like are given as examples of the plurality of sensors 20.

It is assumed that mounting positions in the own-vehicle and ranges in which an object can be detected in the first sensor 20a to the n-th sensor 20n constituting the plurality of sensors 20 are known. The mounting positions of the plurality of sensors 20 can be freely set. However, in the present disclosure, in order to integrate observation values of the object detected by the sensors, it is desirable that the detection ranges of the plurality of sensors 20 overlap, that is, a common portion exists.

In addition, in order to enable an object that cannot be detected by at least one sensor to be detected by another sensor among the plurality of sensors 20, it is preferable that the first sensor 20a, . . . , and the n-th sensor 20n are configured by at least two or more types of sensing methods. For example, it is conceivable that the first sensor 20a is a millimeter wave radar, the n-th sensor 20n is an optical camera, the first sensor 20a is mounted at the center of the front bumper of the own-vehicle, the n-th sensor 20n is mounted on the rear side of the room mirror of the own-vehicle, and the front of the own-vehicle is set as a common detection range of both sensors. Note that, in the following description, the data detected by the first sensor 20a is referred to as a first detection data, and the data detected by the n-th sensor 20n is referred to as an n-th detection data.

The vehicle information sensor 21 mounted on the own-vehicle is a sensor that measures states of the own-vehicle such as velocity, wheel velocity, a steering angle, and a yaw rate of the own-vehicle. Alternatively, the vehicle information sensor 21 may be a sensor that measures latitude, longitude, and a traveling direction of the own-vehicle using a global positioning system (GPS). The information of the own-vehicle acquired by the vehicle information sensor 21 is collectively referred to as own-vehicle data. The above is the description of the plurality of sensors 20 and the vehicle information sensor 21 mounted on the own-vehicle.

### Configuration of Object Recognition Device According to Embodiment 1

The data receiving unit 101 receives the detection data of each sensor from the plurality of sensors 20, and the own-vehicle data from the vehicle information sensor 21. In addition, the data receiving unit 101 associates a common time measured by the time measurement unit 107 to be described later as an associated time with each of the received data. The data receiving unit 101 outputs the detection data associated with the associated time and including ground velocity of the detected object to the received data processing unit 102 and the correlation processing unit 104.

The received data processing unit 102 calculates the detection data density in a specific region 30 on the basis of the received detection data. The received data processing unit 102 outputs the calculated detection data density to the adjusted determination region parameter generation unit 103. Here, the specific region 30 means a preset range, that is, a region, centered on the position of the object predicted by prediction data to be described later, for example. Further, the detection data density in the specific region 30 means a density calculated by dividing the number of detection data existing inside the specific region 30 by the volume of the specific region.

The adjusted determination region parameter generation unit 103 generates an adjusted determination region parameter by adjusting a parameter indicating the size of a determination region on the basis of the detection data density, with respect to the parameter relating to the determination region required when determining whether or not an object predicted by the prediction data from the prediction processing unit 106 and an object based on the detection data are the same object. The adjusted determination region parameter generation unit 103 outputs the generated adjusted determination region parameter to the correlation processing unit 104. Note that the adjusted determination region parameter is a parameter representing the determination region after the adjustment, that is, an adjusted determination region 32.

The correlation processing unit 104 determines the presence or absence of a correlation, that is, a correspondence relationship between the detection data at an associated time and the prediction data predicted from the state values of the object at the immediately preceding associated time in the adjusted determination region 32 determined on the basis of the adjusted determination region parameter, and generates correlation data in which the correlation between the detection data and the prediction data is summarized. The correlation processing unit 104 outputs the correlation data to the update processing unit 105. The presence or absence of the correlation between the detection data and the prediction data is determined using a known simple nearest neighbor (SNN) algorithm, a global nearest neighbor (GNN) algorithm, a joint probabilistic data association (JPDA) algorithm, or the like.

The update processing unit 105 updates the state values of the object on the basis of the correlation data and outputs the state values as the object data to, for example, the display unit 110. The state values of the object are information such as a position, velocity, acceleration, a type of the object, and the like included in the first detection data detected by the first sensor 20a, . . . , and the n-th detection data detected by the n-th sensor 20n, the information each being detected by one of the plurality of sensors 20. The state values of the object are updated at a predetermined operation cycle using, for example, a least squares method, a Kalman filter, a particle filter, or the like.

The prediction processing unit 106 predicts the state values of the object at the reception time being the current associated time included in the detection data using the object data, that is, the state values of the object at the previous associated time (the immediately preceding associated time) output from the update processing unit 105, and generates a prediction result as prediction data. The prediction processing unit 106 outputs the generated prediction data to the correlation processing unit 104. Note that the specific region 30 required for calculating the detection data density is set on the basis of the prediction data.

The time measurement unit 107 measures a time of the object recognition device 200. Note that the time measured by the time measurement unit 107 is referred to as a common time. The object recognition device 200 repeatedly executes a fixed operation at a predetermined operation cycle. For example, the latest past operation cycle with respect to the current operation cycle is referred to as the immediately preceding operation cycle, and the associated time in the immediately preceding operation cycle with respect to the current associated time is referred to as the immediately preceding associated time.

### Object Method According to Embodiment 1

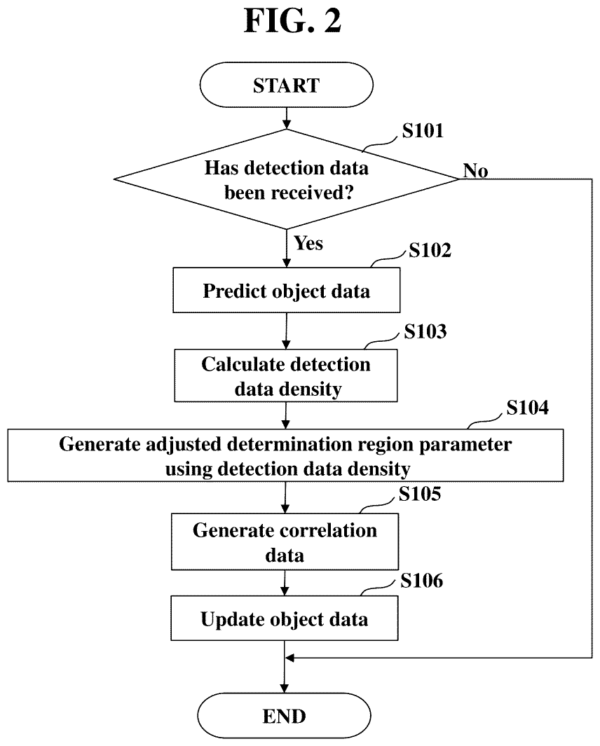

The object recognition method according to Embodiment 1 will be described below with reference to FIG. 2. The object recognition device 200 repeatedly executes the following fixed operation at the predetermined operation cycle. FIG. 2 is a flowchart showing an operation in one operation cycle in the object recognition method according to Embodiment 1.

First, in step S101, the data receiving unit 101 determines whether or not detection data has been received within an operation cycle from at least one sensor among the first sensor 20a, . . . , and the n-th sensor 20n constituting the plurality of sensors 20, for example.

If the result of the determination in step S101 is “Yes”, that is, if the detection data is received from at least one sensor within the operation cycle, the process proceeds to step S102. On the other hand, if the result of the determination in step S101 is “No”, that is, if the detection data is not received within the operation cycle, the process of this operation cycle is terminated.

In step S102, the prediction processing unit 106 predicts the state values of the object at the reception time being the associated time of this time (current associated time) included in the detection data on the basis of the object data (state values of the object) acquired at the immediately preceding associated time, and generates a prediction result as the prediction data.

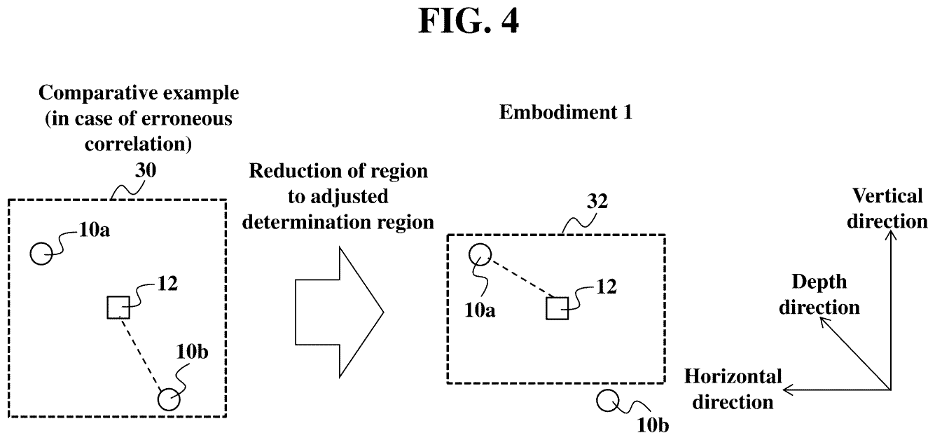

In step S103, the received data processing unit 102 calculates a detection data density in the specific region 30 on the basis of the acquired detection data. As the specific region 30, for example, a fixed region centered on the position of the object predicted by the prediction data can be used. As an example of the specific region 30, a region within a range of ±1 m in the vertical direction, ±1 m in the horizontal direction, and ±1 m in the depth direction in the coordinates illustrated in FIG. 4, with the position of the object according to the prediction data as the center, may be set as the specific region 30. The detection data density is calculated by dividing the number of detection data existing inside the specific region 30 by the volume of the specific region 30.

In step S104, the adjusted determination region parameter generation unit 103 generates an adjusted determination region parameter by adjusting a parameter indicating the size of the determination region on the basis of the detection data density, with respect to the parameter indicating the determination region required when determining whether or not the prediction data from the prediction processing unit 106, namely, the object to be predicted and the object based on the detection data are the same object. The same physical quantity as that of the determination region is used as the adjusted determination region parameter. For example, when a position space is assumed as the determination region, a width, a length, and a depth of a correlation range are adjusted. A specific method of adjusting the parameter indicating the size of the determination region on the basis of the detection data density will be described later.

In step S105, the correlation processing unit 104 acquires the detection data from the data receiving unit 101 and the prediction data from the prediction processing unit 106. In addition, the correlation processing unit 104 acquires the adjusted determination region parameter from the adjusted determination region parameter generation unit 103. The correlation processing unit determines a correspondence relationship between the detection data and the prediction data at the associated time, that is, the correlation, in the adjusted determination region determined on the basis of the adjusted determination region parameter, and generates correlation data in which the correspondence relationship between the detection data and the prediction data is summarized.

In step S106, the update processing unit 105 updates the state values of the object on the basis of the correlation data. The above is a series of operations in one operation cycle by the object recognition method according to Embodiment 1.

### Method of Generating Adjusted Determination Region Parameter

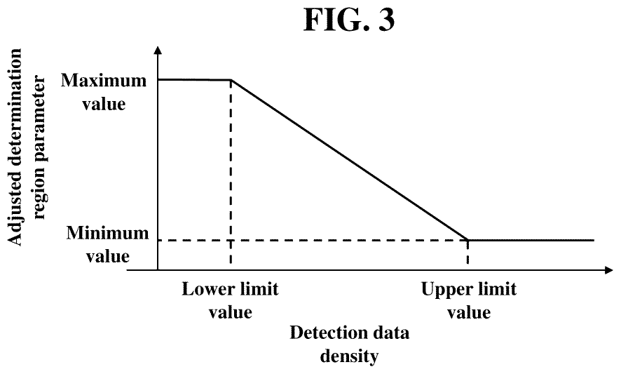

FIG. 3 is a diagram for describing an example of a method of generating the adjusted determination region parameter. In FIG. 3, the horizontal axis represents the detection data density, and the vertical axis represents the adjusted determination region parameter. The maximum value, that is, the determination region parameter maximum value, and the minimum value, that is, the determination region parameter minimum value, are set in advance as the adjusted determination region parameter. That is, the adjusted determination region parameter is a value between the determination region parameter maximum value and the determination region parameter minimum value.

As shown in FIG. 3, when the detection data density is less than a detection data density lower limit value, the adjusted determination region parameter is the determination region parameter maximum value, that is, a constant value. When the detection data density is low, the determination region is set to be wide to prevent the correlation data from being non-correlation. However, when the determination region is set to be too wide, the possibility of occurrence of erroneous correlation increases, and thus the determination region parameter maximum value is set as the upper limit of the adjusted determination region parameter.

When the detection data density is larger than a detection data density upper limit value, the adjusted determination region parameter is the determination region parameter minimum value, that is, a constant value. When the detection data density is high, the determination region is set to be narrow to prevent the correlation data from being erroneous correlation. However, when the determination region is set to be too narrow, the possibility of occurrence of non-correlation increases, and thus the minimum value of the determination region parameter is set as the lower limit of the adjusted determination region parameter.

In a range where the detection data density is equal to or more than the detection data density lower limit value and equal to or less than the detection data density upper limit value, the adjusted determination region parameter is adjusted so as to decrease in proportion to the detection data density as shown in FIG. 3. This is because, within this range, the higher the detection data density is, the narrower the determination region is set, thereby helping to prevent the erroneous correlation.

In summary, the adjusted determination region parameter generation unit 103 sets the adjusted determination region parameter to the determination region parameter maximum value set in advance when the detection data density is less than the detection data density lower limit value, sets the adjusted determination region parameter to the determination region parameter minimum value set in advance when the detection data density is greater than the detection data density upper limit value, and adjusts the adjusted determination region parameter to decrease in proportion to the detection data density when the detection data density is within the range from the detection data density lower limit value to the detection data density upper limit value.

### Application Example of Object Recognition Device and Object Recognition Method According to Embodiment 1

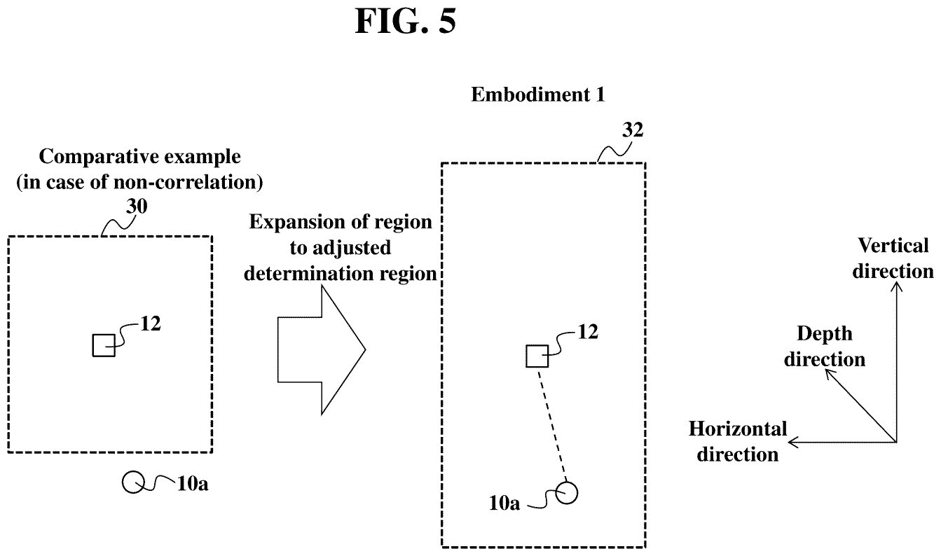

The features of the object recognition device and the object recognition method according to Embodiment 1 will be described in comparison with a comparative example. FIG. 4 and FIG. 5 are diagrams for describing application examples of the object recognition method using the object recognition device 200 according to Embodiment 1. FIG. 4 and FIG. 5 assume the position space. The position space can be expressed by a vertical position in the vertical axis, a horizontal position in the horizontal axis, and a depth position in the depth axis.

### Application Example I

In the left side of FIG. 4, an operation of the object recognition method according to the comparative example is shown, and in the right side thereof, the operation of the object recognition method according to Embodiment 1 is shown. In FIG. 4, a hollow square mark represents the prediction data 12 predicted from the state values of an object at the immediately preceding associated time, and hollow circle marks represent the detection data 10a and 10b. The detection data 10a represents detection data caused by the same object as the prediction data 12. On the other hand, the detection data 10b represents detection data caused by an object different from the prediction data 12. Note that, in the example shown in FIG. 4, it is assumed that the correlation is performed, for example, in consideration of the velocity in addition to the position information. In the example shown in FIG. 4, the correct correlation is that the update data is calculated such that the prediction data 12 is in correspondence with the detection data 10a.

In the comparative example shown on the left side of FIG. 4, the determination region is a region having a fixed region set in advance and does not depend on the detection data density with the position of the object predicted by the prediction data 12 as the center. That is, the determination region means the same region as the specific region in the object recognition method according to Embodiment 1. In the comparative example, since the detection data density is high, the detection data 10a correlated with the prediction data 12 exists in the determination region, whereas the detection data 10b not correlated with the prediction data 12 also exists in the determination region. Therefore, there is a possibility that the correct correlation between the prediction data 12 and the detection data 10a is not recognized and there is erroneous correlation that occurs between the prediction data 12 and the detection data 10b.

On the other hand, in the object recognition method according to Embodiment 1 shown on the right side in FIG. 4, the adjusted determination region parameter generation unit 103 generates the adjusted determination region parameter by adjusting the parameter indicating the size of the determination region, and determines the correlation between the prediction data and the detection data using the adjusted determination region 32. In the example shown in FIG. 4, since the detection data density is high, the adjusted determination region 32 is set to be relatively narrower than the determination region according to the comparative example, that is, the specific region. As a result, the detection data 10b is located outside the adjusted determination region 32, and thus the correct correlation between the prediction data 12 and the detection data 10a can be recognized. That is, according to the object recognition method of Embodiment 1, the possibility of occurrence of the erroneous correlation is drastically reduced as compared with the object recognition method of the comparative example.

### Application Example II

In the left side of FIG. 5, an operation of the object recognition method according to the comparative example is shown, and in the right side thereof, the operation of the object recognition method according to Embodiment 1 is shown. In FIG. 5, a hollow square mark represents the prediction data 12 predicted from the state values of an object at the immediately preceding associated time, and hollow circle marks represent the detection data 10a and 10b. The detection data 10a represents detection data caused by the same object as the prediction data 12. Note that, in the example shown in FIG. 5, it is assumed that the correlation is performed, for example, in consideration of the velocity in addition to the position information. In the example shown in FIG. 5, the correct correlation is that the update data is calculated such that the prediction data 12 is in correspondence with the detection data 10a.

In the comparative example shown on the left side of FIG. 5, the determination region is a region having a fixed region set in advance and does not depend on the detection data density with the position of the object predicted by the prediction data 12 as the center. That is, the determination region means the same region as the specific region in the object recognition method according to Embodiment 1. In the comparative example, since the detection data density is low, the detection data 10a correlated with the prediction data 12 does not exist in the determination region. Therefore, there is a possibility that correct correlation between the prediction data 12 and the detection data 10a is not recognized and non-correlation between the prediction data 12 and the detection data 10b occurs.

In contrast, in the object recognition method according to Embodiment 1 shown on the right side of FIG. 5, the adjusted determination region parameter generation unit 103 generates an adjusted determination region parameter by adjusting a parameter indicating the size of the determination region, and determines the correlation between the prediction data and the detection data using the adjusted determination region 32. In the example shown in FIG. 5, since the detection data density is low, the adjusted determination region 32 is set to be relatively wider than the determination region according to the comparative example, that is, the specific region. As a result, the detection data 10a is located inside the adjusted determination region 32, and thus the correct correlation between the prediction data 12 and the detection data 10a can be recognized. That is, according to the object recognition method of Embodiment 1, the possibility of occurrence of non-correlation is drastically reduced as compared with the object recognition method of the comparative example.

### Effect of Embodiment 1

As described above, according to the object recognition device and the object recognition method of Embodiment 1, it is possible to adjust the determination region required for determining the correlation between the prediction data and the detection data of the object using the detection data density, and thus it is possible to prevent the correlation from being a wrong combination (erroneous correlation) or correct detection data from being outside the determination region (non-correlation). As a result, it is possible to perform object recognition with high accuracy.

### Embodiment 2

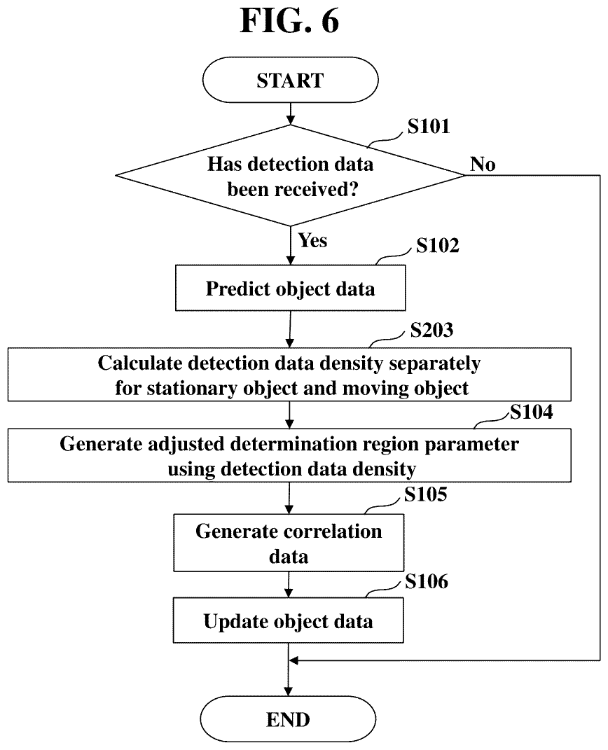

FIG. 6 is a flowchart showing an operation in a certain operation cycle in an object recognition method according to Embodiment 2. In the object recognition method according to Embodiment 2, instead of step S103 in the flowchart of FIG. 2, a process of step S203 of calculating of the detection value density separately for a stationary object and a moving object is performed. Since the detection data density is different between the stationary object and the moving object, the adjusted determination region parameter generated on the basis of the detection data also has a different value between the stationary object and the moving object. Whether the target object is a stationary object or a moving object is determined on the basis of the velocity or the acceleration calculated from the detection data. Since the correlation is determined by applying an appropriate detection data density according to the state of the object, an effect is brought about in that object recognition with higher accuracy can be performed.

The adjustment of the specific region 30 used for the calculation of the detection data density in step S203 may be performed using not only the position of the prediction data but also the velocity and the acceleration of the target object. When the velocity is taken as an example, the specific region 30 is set to a region within ±3 km/h in the vertical direction, ±3 km/h in the horizontal direction, and ±3 km/h in the depth direction with respect to the velocity calculated from the prediction data, and the detection data density is calculated from the number of detection data existing inside the specific region 30. Thus, the adjusted determination region parameter can be set on the basis of a plurality of physical quantities, and therefore, an effect is brought about in that the accuracy of the correlation can be further improved as compared with the case of a single physical quantity.

Further, after step S102 in the flowchart of FIG. 6, a process may be performed in such a way that a step of determining “Ground velocity of detected object >Threshold velocity?” is added, and if the determination result is “Yes”, the object is added as the calculation target for the detection data density, or if the determination result is “No”, the detected object that is of smaller than the threshold velocity is excluded as the calculation target the for detection data density. This produces an effect of reducing the calculation load of the detection data density and preventing unintended adjustment of the correlation due to a large stationary object such as a guardrail.

In the process of step S104, the detection data density to be used may be set as a filtered value of the detection data density. That is, the received data processing unit 102 resets the filtered value of the detection data density to the detection data density. For example, a step of “Calculating filtered value of L cycles” is added before step S104. An example of the filtered value is a moving average value of L cycles (L is an integer of 1 or more). By adding such a process, an effect is achieved that unintended adjustment of the correlation due to sudden noise can be prevented.

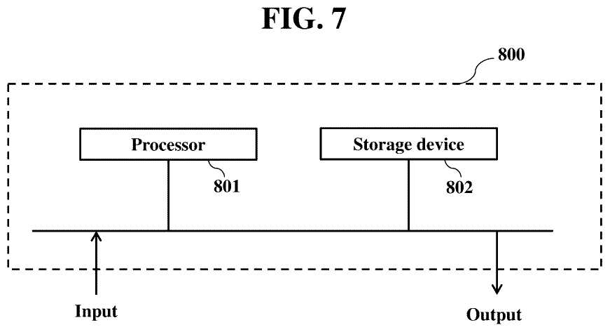

In the configuration of the object recognition device 200 according to Embodiment 1 described above, the object recognition device 200 is described as a functional block, but an example of a configuration as hardware that includes the object recognition device 200 is shown in FIG. 7. Hardware 800 is configured by a processor 801 and a storage device 802. The storage device 802 includes a volatile storage device such as a random access memory and a nonvolatile auxiliary storage device such as a flash memory, which are not shown.

Further, an auxiliary storage device such as a hard disk may be provided instead of the flash memory. The processor 801 executes a program input from the storage device 802. In this case, the program is input from the auxiliary storage device to the processor 801 via the volatile storage device. Further, the processor 801 may output data such as a calculation result to the volatile storage device of the storage device 802 or may store data in the auxiliary storage device via the volatile storage device.

Although various exemplary embodiments and examples are described in the present disclosure, various features, aspects, and functions described in one or more embodiments are not limited to an application in a particular embodiment, and can be applicable alone or in their various combinations to each embodiment.

Accordingly, countless variations that are not illustrated are envisaged within the scope of the technology disclosed in the specification of the present application. For example, the case where at least one component is modified, added or omitted, and the case where at least one component is extracted and combined with a component in another embodiment are included.

### DESCRIPTION OF THE REFERENCE CHARACTERS

10a 10b: detection data
12: prediction data
20: plurality of sensors
20a: first sensor
20n: n-th sensor
21: vehicle information sensor
30: specific region
32: adjusted determination region
101: data receiving unit
102: received data processing unit
103: adjusted determination region parameter generation unit
104: correlation processing unit
105: update processing unit
106: prediction processing unit
107: time measurement unit
110: display unit
200: object recognition device
800: hardware
801: processor
802: storage device

1. An object recognition device comprising at least one processor configured to implement:
a time measurement circuitry to measure a time;
a data receiver to receive detection data of an object from each of a plurality of sensors and associate the time measured by the time measurement circuitry as an associated time with each of the received detection data;
a received data processing circuitry to calculate a detection data density in a specific region set using prediction data on a basis of the detection data;
a prediction processing circuitry to predict a state value of the object corresponding to the associated time associated by the data receiver from a state value of the object at an immediately preceding associated time and generate a prediction result as the prediction data;
an adjusted determination region parameter generator to generate an adjusted determination region parameter by adjusting a parameter indicating a size of a determination region on a basis of the detection data density, the determination region being used for determining whether the prediction data and the detection data are based on the same object;
a correlation processing circuitry to generate correlation data indicating a correlation between the prediction data and the detection data corresponding to the associated time in the adjusted determination region indicated by the adjusted determination region parameter; and
an update processing circuitry to update the state value of the object on a basis of the correlation data.

2. The object recognition device according to claim 1, wherein the adjusted determination region parameter generator sets the adjusted determination region parameter to a determination region parameter maximum value set in advance when the detection data density is less than a detection data density lower limit value, sets the adjusted determination region parameter to a determination region parameter minimum value set in advance when the detection data density is greater than a detection data density upper limit value, and decreases the adjusted determination region parameter in proportion to the detection data density when the detection data density is within a range from the detection data density lower limit value to the detection data density upper limit value.

3. The object recognition device according to claim 1, wherein the received data processing circuitry determines whether the object is a stationary object or a moving object on a basis of ground velocity of the object calculated from the detection data, and calculates the detection data density separately in a case of the stationary object and in a case of the moving object.

4. The object recognition device according to claim 1, wherein, when the detection data density is calculated, the received data processing circuitry determines the specific region on a basis of one or more of a position, velocity, and acceleration of the detection data.

5. The object recognition device according to claim 1, wherein the received data processing circuitry resets a filtered value of the detection data density to the detection data density.

6. An object recognition method comprising:
measuring a time;
receiving detection data of an object from each of a plurality of sensors and associating the time measured as an associated time with each of the received detection data;
calculating a detection data density in a specific region on a basis of the detection data;
predicting a state value of the object corresponding to the associated time from a state value of the object at an immediately preceding associated time and generating a prediction result as prediction data;
generating an adjusted determination region parameter by adjusting a parameter indicating a size of a determination region on a basis of the detection data density, the determination region being used for determining whether the prediction data and the detection data are based on the same object;
generating correlation data indicating a correlation between the prediction data and the detection data corresponding to the associated time in the adjusted determination region indicated by the adjusted determination region parameter; and
updating the state value of the object on a basis of the correlation data.

7. The object recognition method according to claim 6, wherein, in generating the adjusted determination region parameter, the adjusted determination region parameter is set to a determination region parameter maximum value set in advance when the detection data density is less than a detection data density lower limit value, the adjusted determination region parameter is set to a determination region parameter minimum value set in advance when the detection data density is greater than a detection data density upper limit value, and the adjusted determination region parameter is decreased in proportion to the detection data density when the detection data density is within a range from the detection data density lower limit value to the detection data density upper limit value.

8. The object recognition device according to claim 2, wherein the received data processing circuitry determines whether the object is a stationary object or a moving object on a basis of ground velocity of the object calculated from the detection data, and calculates the detection data density separately in a case of the stationary object and in a case of the moving object.

9. The object recognition device according to claim 2, wherein, when the detection data density is calculated, the received data processing circuitry determines the specific region on a basis of one or more of a position, velocity, and acceleration of the detection data.

10. The object recognition device according to claim 2, wherein the received data processing circuitry resets a filtered value of the detection data density to the detection data density.

11. The object recognition device according to claim 3, wherein, when the detection data density is calculated, the received data processing circuitry determines the specific region on a basis of one or more of a position, velocity, and acceleration of the detection data.

12. The object recognition device according to claim 3, wherein the received data processing circuitry resets a filtered value of the detection data density to the detection data density.

13. The object recognition device according to claim 4, wherein the received data processing circuitry resets a filtered value of the detection data density to the detection data density.
